(19) United States
(12) Patent Application Publication
(10) Pub. No.: US 2023/0298217 A1
(43) Pub. Date: Sep. 21, 2023

(54) Hierarchical V3C Patch Remeshing For Dynamic Mesh Coding

(71) Applicant: Nokia Technologies Oy, Espoo (FI)

(72) Inventors: Patrice Rondao Alface, Evere (BE); Aleksei Martemianov, Tampere (FI); Lukasz Kondrad, Munich (DE); Lauri Aleksi Ilola, Munich (DE); Sebastian Schwarz, Unterhaching (DE)

(21) Appl. No.: 18/116,953

(22) Filed: Mar. 3, 2023

Related U.S. Application Data
(60) Provisional application No. 63/321,208, filed on Mar. 18, 2022.

(51) Int. Cl. G06T 9/00; G06T 19/20

(52) U.S. Cl. CPC G06T 9/001; G06T 19/20; G06T 2219/2021

(57) ABSTRACT

An apparatus comprising circuitry configured to: receive scalability information, the scalability information comprising a number of at least one layer of a three-dimensional object, and at least one sampling rate for the layer; subsample a geometry component of a patch of the three-dimensional object at occupied positions, based on the sampling rate for the layer; define respective search windows around the respective occupied positions; select respective salient points relative to the respective occupied positions within the respective search windows; triangulate the salient points to approximate a shape of a three-dimensional object; detect zero or more triangles that overlap with at least one unoccupied pixel; split the zero or more triangles that overlap with at least one unoccupied pixel until no triangle overlaps with the unoccupied pixels; and add zero or more additional triangles close to a border of the three-dimensional object to generate a resulting mesh for the layer.

### RELATED APPLICATION

This application claims priority to U.S. Provisional Application No. 63/321,208, filed Mar. 18, 2022, which is hereby incorporated by reference in its entirety.

### TECHNICAL FIELD

The examples and non-limiting embodiments relate generally to volumetric video coding, and more particularly, to hierarchical V3C patch remeshing for dynamic mesh coding.

### BACKGROUND

It is known to perform encoding and decoding of video using an encoder and a decoder.

### SUMMARY

In accordance with an aspect, an apparatus includes: at least one processor; and at least one non-transitory memory storing instructions that, when executed by the at least one processor, cause the apparatus at least to: receive scalability information, the scalability information comprising a number of at least one layer of a three-dimensional object, and at least one sampling rate for the at least one layer; subsample a geometry component of a patch of the three-dimensional object at occupied positions, based on the sampling rate for the at least one layer; define respective search windows around the respective occupied positions; select respective salient points relative to the respective occupied positions within the respective search windows; triangulate the salient points to approximate a shape of a three-dimensional object; detect zero or more triangles that overlap with at least one unoccupied pixel; split the zero or more triangles that overlap with at least one unoccupied pixel until no triangle overlaps with the unoccupied pixels; and add zero or more additional triangles close to a border of the three-dimensional object to generate a resulting mesh for the at least one layer.

In accordance with an aspect, an apparatus includes: at least one processor; and at least one non-transitory memory storing instructions that, when executed by the at least one processor, cause the apparatus at least to: determine scalability information, the scalability information comprising a number of at least one layer of a three-dimensional object, and at least one sampling rate for the at least one layer; and transmit the scalability information to a decoder; wherein the sampling rate is configured to be used with the decoder to subsample a geometry component of a patch of the three-dimensional object at occupied positions; wherein the at least one sampling rate defines a level of detail at which the geometry component is subsampled, where the level of detail increases as fewer occupied positions are subsampled, and where the level of detail is chosen depending on an operating parameter of a rendering device or viewer distance; wherein the scalability information is configured to be used with the decoder to reconstruct a mesh at different operating points to approximate a shape of the three-dimensional object.

In accordance with an aspect, an apparatus includes: at least one processor; and at least one non-transitory memory storing instructions that, when executed by the at least one processor, cause the apparatus at least to: receive scalability information, the scalability information comprising a number of at least one layer of a three-dimensional object, and at least one sampling rate for the at least one layer; generate a mesh using a depth patch triangulation method using the scalability information to approximate a shape of the three-dimensional object; evaluate a quality of a depth patch triangulation compared to a reconstructed three-dimensional object reconstructed without triangulated depth patches; and iterate until a reconstructed three-dimensional object using the depth patch triangulation method reaches an expected improved quality.

### BRIEF DESCRIPTION OF THE DRAWINGS

The foregoing aspects and other features are explained in the following description, taken in connection with the accompanying drawings, wherein:

FIG. 1A is a diagram showing volumetric media conversion at an encoder side.

FIG. 1B is a diagram showing volumetric media reconstruction at a decoder side.

FIG. 2 shows an example of block to patch mapping.

FIG. 3A shows an example of an atlas coordinate system.

FIG. 3B shows an example of a local 3D patch coordinate system.

FIG. 3C shows an example of a final target 3D coordinate system.

FIG. 4 shows elements of a mesh.

FIG. 5 shows an example V-PCC extension for mesh encoding, based on the embodiments described herein.

FIG. 6 shows an example V-PCC extension for mesh decoding, based on the embodiments described herein.

FIG. 7A shows a patch depth map (geometry component) with unoccupied pixels represented as dashed circles.

FIG. 7B shows a straightforward regular triangulation of occupied (valid) pixels of the depth map (geometry component) shown in FIG. 7A.

FIG. 8A shows regular meshing of a V3C patch.

FIG. 8B shows simple subsampling of a V3C patch.

FIG. 9 illustrates example signaling of the method described herein as an extension to an atlas sequence parameter set syntax element.

FIG. 10 illustrates example signaling of the method described herein as an extension to a patch data unit syntax element.

FIG. 11A shows the V3C patch depth map (geometry component) represented with dotted circles on invalid/unoccupied pixels.

FIG. 11B shows a subsampling of the depth map (geometry component) that is signaled in the V3C bitstream.

FIG. 12A shows defining a search window during local optimization.

FIG. 12B shows selecting a salient point during local optimization.

FIG. 13A shows a resulting mesh when no local optimization is performed.

FIG. 13B shows the resulting triangulation after local optimization.

FIG. 14A shows non-coverage of unoccupied pixels, where edges are represented for two triangles that overlap unoccupied pixels in their vicinity.

FIG. 14B shows non-coverage of unoccupied pixels, namely a process of triangle correction.

FIG. 15A shows a refinement step, where additional samples and triangles are added close to the borders.

FIG. 15B shows a refinement step, with the resulting mesh with larger triangles in the core of the patch and finer triangles close to the boundaries.

FIG. 16 is an example apparatus to implement hierarchical V3C patch remeshing for dynamic mesh coding, based on the examples described herein.

FIG. 17 is an example method to implement hierarchical V3C patch remeshing for dynamic mesh coding, based on the examples described herein.

FIG. 18 is example encoder-side method to implement hierarchical V3C patch remeshing for dynamic mesh coding, based on the examples described herein.

FIG. 19 is example decoder-side method to implement hierarchical V3C patch remeshing for dynamic mesh coding, based on the examples described herein.

### DETAILED DESCRIPTION OF EXAMPLE EMBODIMENTS

The examples described herein relate to the encoding, signaling and rendering of a volumetric video that is based on mesh coding. The examples described herein focus on methods improving the quality of reconstructed mesh surfaces. The examples described herein relate to methods to improve quality of decoded mesh textures and geometry by using its hierarchical representation which as a consequence increases compression efficiency of the encoding pipeline.

Volumetric Video Data

Volumetric video data represents a three-dimensional scene or object and can be used as input for AR, VR and MR applications. Such data describes geometry (shape, size, position in 3D-space) and respective attributes (e.g. color, opacity, reflectance, plus any possible temporal transformations of the geometry and attributes at given time instances (like frames in 2D video). Volumetric video is either generated from 3D models, i.e. CGI, or captured from real-world scenes using a variety of capture solutions, e.g. multi-camera, laser scan, combination of video and dedicated depth sensors, and more. Also, a combination of CGI and real-world data is possible. Typical representation formats for such volumetric data are triangle meshes, point clouds, or voxels. Temporal information about the scene can be included in the form of individual capture instances, i.e. “frames” in 2D video, or other means, e.g. position of an object as a function of time.

Because volumetric video describes a 3D scene (or object), such data can be viewed from any viewpoint. Therefore, volumetric video is an important format for AR, VR, or MR applications, especially for providing 6DOF viewing capabilities.

Increasing computational resources and advances in 3D data acquisition devices have enabled reconstruction of highly detailed volumetric video representations of natural scenes. Infrared, lasers, time-of-flight and structured light are all examples of devices that can be used to construct 3D video data. Representation of the 3D data depends on how the 3D data is used. Dense voxel arrays have been used to represent volumetric medical data. In 3D graphics, polygonal meshes are extensively used. Point clouds on the other hand are well suited for applications such as capturing real world 3D scenes where the topology is not necessarily a 2D manifold. Another way to represent 3D data is coding this 3D data as a set of textures and a depth map as is the case in the multi-view plus depth framework. Closely related to the techniques used in multi-view plus depth is the use of elevation maps, and multi-level surface maps.

MPEG Visual Volumetric Video-Based Coding (V3C)

Selected excerpts from the ISO/IEC 23090-5 Visual Volumetric Video-based Coding and Video-based Point Cloud Compression 2nd Edition standard are referred to herein.

Visual volumetric video, a sequence of visual volumetric frames, if uncompressed, may be represented by a large amount of data, which can be costly in terms of storage and transmission. This has led to the need for a high coding efficiency standard for the compression of visual volumetric data.

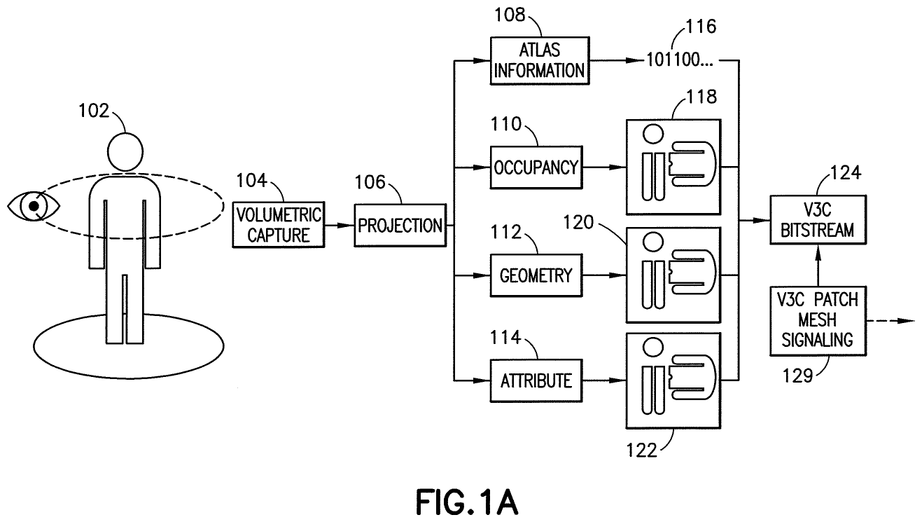

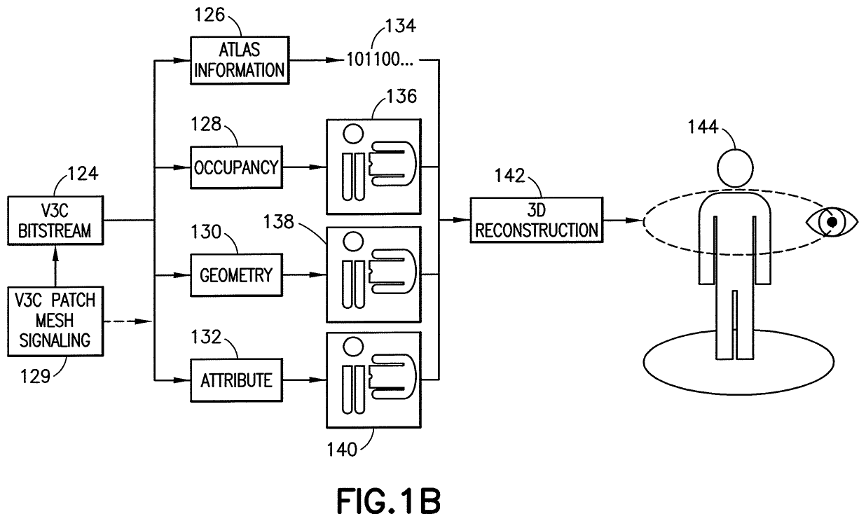

The V3C specification enables the encoding and decoding processes of a variety of volumetric media by using video and image coding technologies. This is achieved through first a conversion of such media from their corresponding 3D representation to multiple 2D representations, also referred to as V3C components, before coding such information. Such representations may include occupancy, geometry, and attribute components. The occupancy component can inform a V3C decoding and/or rendering system of which samples in the 2D components are associated with data in the final 3D representation. The geometry component contains information about the precise location of 3D data in space, while attribute components can provide additional properties, e.g. texture or material information, of such 3D data. An example is shown in FIG. 1A and FIG. 1B.

FIG. 1A shows volumetric media conversion at the encoder, and FIG. 1B shows volumetric media conversion at the decoder side. The 3D media 102 is converted to a series of 2D representations: occupancy 118, geometry 120, and attribute 122. Additional atlas information 108 is also included in the bitstream to enable inverse reconstruction. Refer to ISO/IEC 23090-5.

As further shown in FIG. 1A, a volumetric capture operation 104 generates a projection 106 from the input 3D media 102. In some examples, the projection 106 is a projection operation. From the projection 106, an occupancy operation 110 generates the occupancy 2D representation 118, a geometry operation 112 generates the geometry 2D representation 120, and an attribute operation 114 generates the attribute 2D representation 122. The additional atlas information 108 is included in the bitstream 116. The atlas information 108, the occupancy 2D representation 118, the geometry 2D representation 120, and the attribute 2D representation 122 are encoded into the V3C bitstream 124 to encode a compressed version of the 3D media 102. Based on the examples described herein, V3C patch mesh signaling 129 may also be signaled in the V3C bitstream 124 or directly to a decoder. The V3C patch mesh signaling 129 may be used on the decoder side, as shown in FIG. 1B.

As shown in FIG. 1B, a decoder using the V3C bitstream 124 derives 2D representations using an occupancy operation 128, a geometry operation 130 and an attribute operation 132. The atlas information operation 126 provides atlas information into a bitstream 134. The occupancy operation 128 derives the occupancy 2D representation 136, the geometry operation 130 derives the geometry 2D representation 138, and the attribute operation 132 derives the attribute 2D representation 140. The 3D reconstruction operation 142 generates a decompressed reconstruction 144 of the 3D media 102, using the atlas information 126/134, the occupancy 2D representation 136, the geometry 2D representation 138, and the attribute 2D representation 140.

Additional information that allows associating all these subcomponents and enables the inverse reconstruction, from a 2D representation back to a 3D representation is also included in a special component, referred to herein as the atlas. An atlas consists of multiple elements, namely patches. Each patch identifies a region in all available 2D components and contains information necessary to perform the appropriate inverse projection of this region back to the 3D space. The shape of such regions is determined through a 2D bounding box associated with each patch as well as their coding order. The shape of these regions is also further refined after the consideration of the occupancy information.

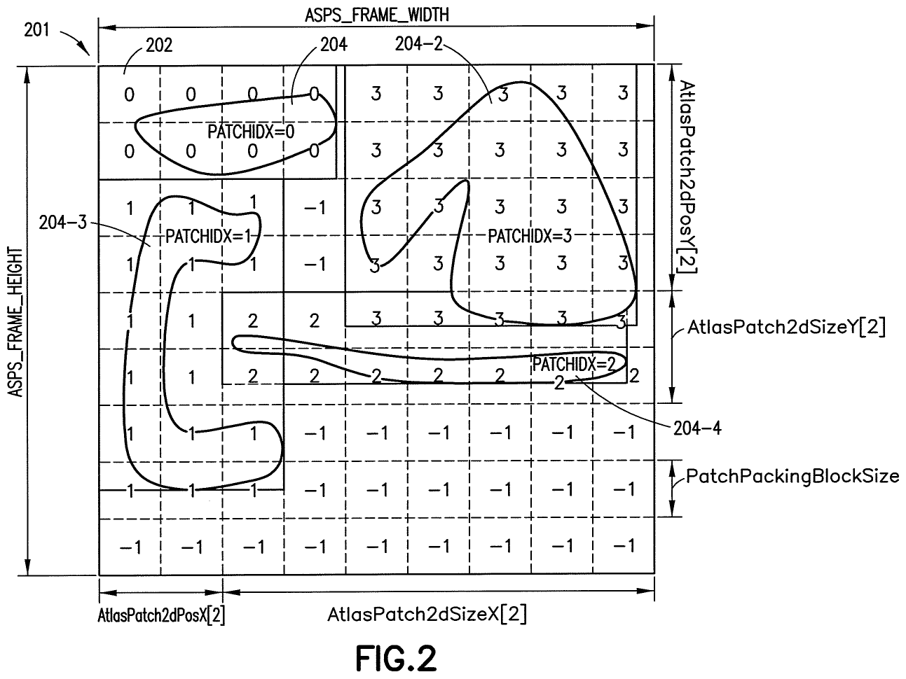

Atlases are partitioned into patch packing blocks of equal size. Refer for example to block 202 in FIG. 2, where FIG. 2 shows an example of block to patch mapping. The 2D bounding boxes of patches and their coding order determine the mapping between the blocks of the atlas image and the patch indices. FIG. 2 shows an example of block to patch mapping with 4 projected patches (204, 204-2, 204-3, 204-4) onto an atlas 201 when asps_patch_precedence_order_flag is equal to 0. Projected points are represented with dark gray. The area that does not contain any projected points is represented with light grey. Patch packing blocks 202 are represented with dashed lines. The number inside each patch packing block 202 represents the patch index of the patch (204, 204-2, 204-3, 204-4) to which it is mapped.

Axes orientations are specified for internal operations. For instance, the origin of the atlas coordinates is located on the top-left corner of the atlas frame. For the reconstruction step, an intermediate axes definition for a local 3D patch coordinate system is used. The 3D local patch coordinate system is then converted to the final target 3D coordinate system using appropriate transformation steps.

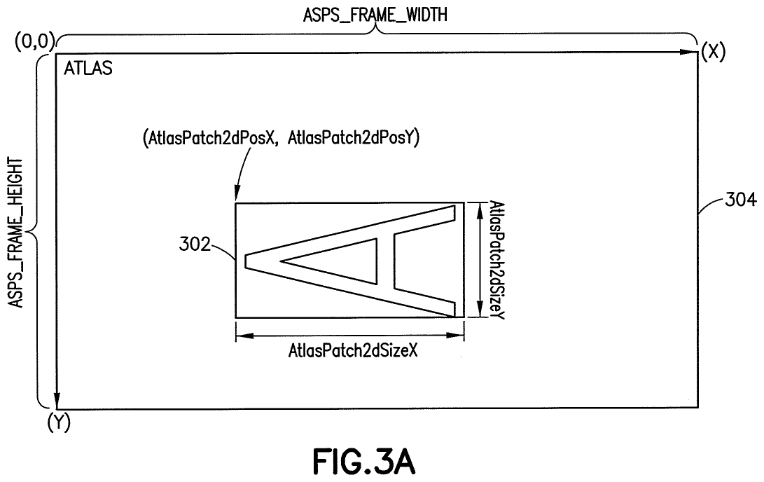

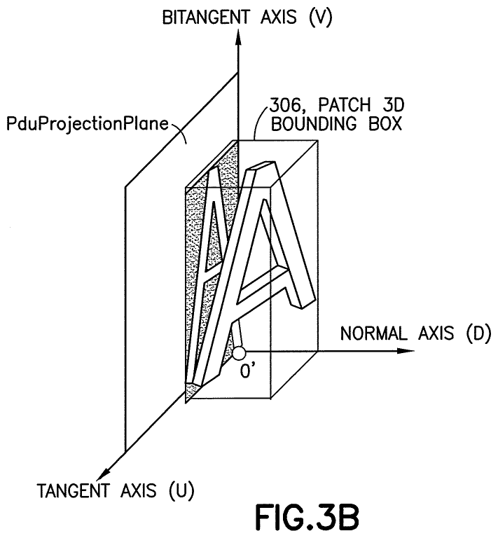

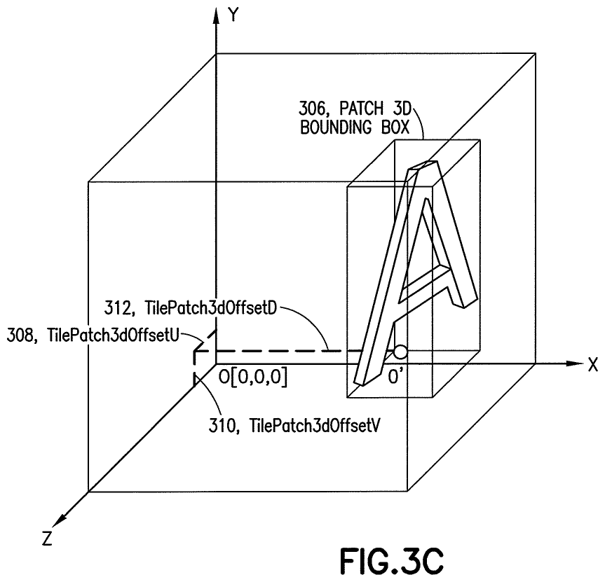

FIG. 3A shows an example of an atlas coordinate system, FIG. 3B shows an example of a local 3D patch coordinate system, and FIG. 3C shows an example of a final target 3D coordinate system. Refer to ISO/IEC 23090-5.

FIG. 3A shows an example of a single patch 302 packed onto an atlas image 304. This patch 302 is then converted, with reference to FIG. 3B, to a local 3D patch coordinate system (U, V, D) defined by the projection plane with origin O′, tangent (U), bi-tangent (V), and normal (D) axes. For an orthographic projection, the projection plane is equal to the sides of an axis-aligned 3D bounding box 306, as shown in FIG. 3B. The location of the bounding box 306 in the 3D model coordinate system, defined by a left-handed system with axes (X, Y, Z), can be obtained by adding offsets TilePatch3dOffsetU 308, TilePatch3DOffsetV 310, and TilePatch3DOffsetD 312, as illustrated in FIG. 3C.

V3C High Level Syntax

Coded V3C video components are referred to herein as video bitstreams, while an atlas component is referred to as the atlas bitstream. Video bitstreams and atlas bitstreams may be further split into smaller units, referred to herein as video and atlas sub-bitstreams, respectively, and may be interleaved together, after the addition of appropriate delimiters, to construct a V3C bitstream.

V3C patch information is contained in an atlas bitstream, atlas_sub_bitstream( ) which contains a sequence of NAL units. A NAL unit is specified to format data and provide header information in a manner appropriate for conveyance on a variety of communication channels or storage media. All data are contained in NAL units, each of which contains an integer number of bytes. A NAL unit specifies a generic format for use in both packet-oriented and bitstream systems. The format of NAL units for both packet-oriented transport and sample streams is identical except that in the sample stream format specified in Annex D of ISO/IEC 23090-5 each NAL unit can be preceded by an additional element that specifies the size of the NAL unit.

NAL units in an atlas bitstream can be divided into atlas coding layer (ACL) and non-atlas coding layer (non-ACL) units. The former is dedicated to carry patch data, while the latter is dedicated to carry data necessary to properly parse the ACL units or any additional auxiliary data.

In the nal_unit_header( )syntax nal_unit type specifies the type of the RBSP data structure contained in the NAL unit as specified in Table 4 of ISO/IEC 23090-5. nal_layer_id specifies the identifier of the layer to which an ACL NAL unit belongs or the identifier of a layer to which a non-ACL NAL unit applies. The value of nal_layer_id shall be in the range of 0 to 62, inclusive. The value of 63 may be specified in the future by ISO/IEC. Decoders conforming to a profile specified in Annex A of ISO/IEC 23090-5 shall ignore (i.e., remove from the bitstream and discard) all NAL units with values of nal_layer_id not equal to 0.

V3C Extension Mechanisms

While designing the V3C specification it was envisaged that amendments or new editions can be created in the future. In order to ensure that the first implementations of V3C decoders are compatible with any future extension, a number of fields for future extensions to parameter sets were reserved.

For example, the second edition of V3C introduced an extension in VPS related to MIV and the packed video component.

| | |
|---|---|
| ... | |
| vps_extension_present_flag | u(1) |
| if( vps_extension_present_flag ) { | |
| vps_packing_information_present_flag | u(1) |
| vps_miv_extension_present_flag | u(1) |
| vps_extension_6bits | u(6) |
| } | |
| if( vps_packing_information_present_flag ) { | |
| for( k=0 ; k <= vps_atlas_count_minus1; k++ ) { | |
| j = vps_atlas_id[ k ] | |
| vps_packed_video_present_flag[ j ] | |
| if( vps_packed_video_present_flag[ j ] ) | |
| packing_information( j ) | |
| } | |
| } | |
| if( vps_miv_extension_present_flag ) | |
| vps_miv_extension( ) /*Specified in ISO/IEC 23090-12 (Under | |
| preparation. Stage at time of publication: ISO/IEC CD 23090-12:2020)*/ | |
| if( vps_extension_6bits ) { | |
| vps_extension_length_minus1 | ue(v) |
| for( j = 0; j < vps_extension_length_minus1+1;j++ ) { | |
| vps_extension_data_byte | u(8) |
| } | |
| } | |
| byte_alignment( ) | |
| } | |

Rendering and Meshes

A polygon mesh is a collection of vertices, edges and faces that defines the shape of a polyhedral object in 3D computer graphics and solid modeling. The faces usually consist of triangles (triangle mesh), quadrilaterals (quads), or other simple convex polygons (n-gons), since this simplifies rendering, but may also be more generally composed of concave polygons, or even polygons with holes.

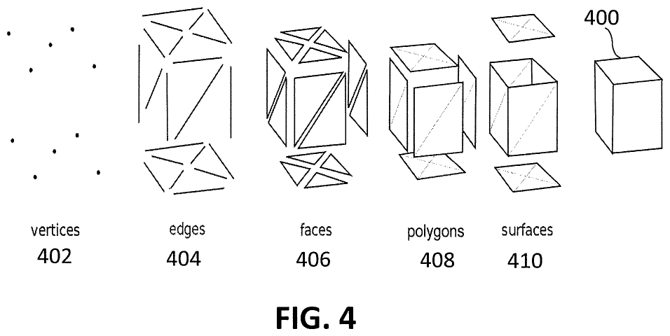

With reference to FIG. 4, objects 400 created with polygon meshes are represented by different types of elements. These include vertices 402, edges 404, faces 406, polygons 408 and surfaces 410 as shown in FIG. 4. Thus, FIG. 4 illustrates elements of a mesh.

Polygon meshes are defined by the following elements:

Vertex (402): a position in 3D space defined as (x,y,z) along with other information such as color (r,g,b), normal vector and texture coordinates.

Edge (404): a connection between two vertices.

Face (406): a closed set of edges 404, in which a triangle face has three edges, and a quad face has four edges. A polygon 408 is a coplanar set of faces 406. In systems that support multi-sided faces, polygons and faces are equivalent. Mathematically a polygonal mesh may be considered an unstructured grid, or undirected graph, with additional properties of geometry, shape and topology.

Surfaces (410): or smoothing groups, are useful, but not required to group smooth regions.

Groups: some mesh formats contain groups, which define separate elements of the mesh, and are useful for determining separate sub-objects for skeletal animation or separate actors for non-skeletal animation.

Materials: defined to allow different portions of the mesh to use different shaders when rendered.

UV coordinates: most mesh formats also support some form of UV coordinates which are a separate 2D representation of the mesh “unfolded” to show what portion of a 2-dimensional texture map to apply to different polygons of the mesh. It is also possible for meshes to contain other such vertex attribute information such as color, tangent vectors, weight maps to control animation, etc. (sometimes also called channels).

V-PCC mesh coding extension (MPEG M49588)

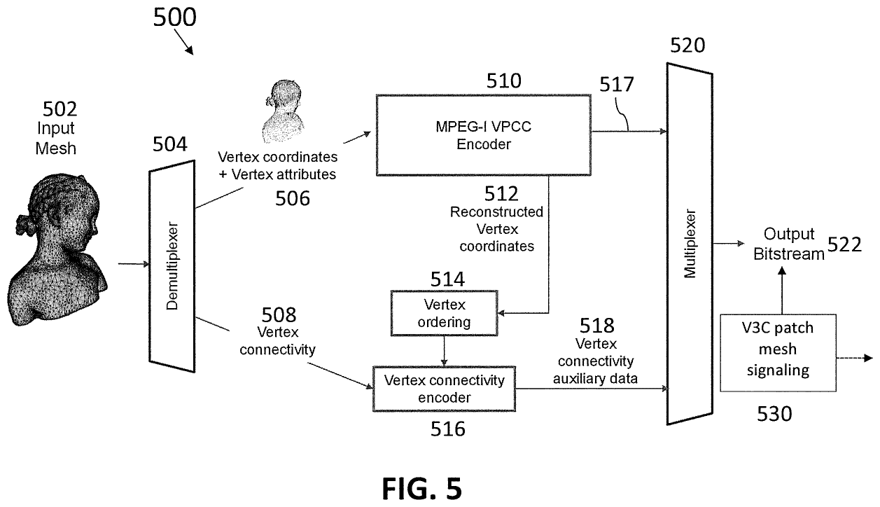

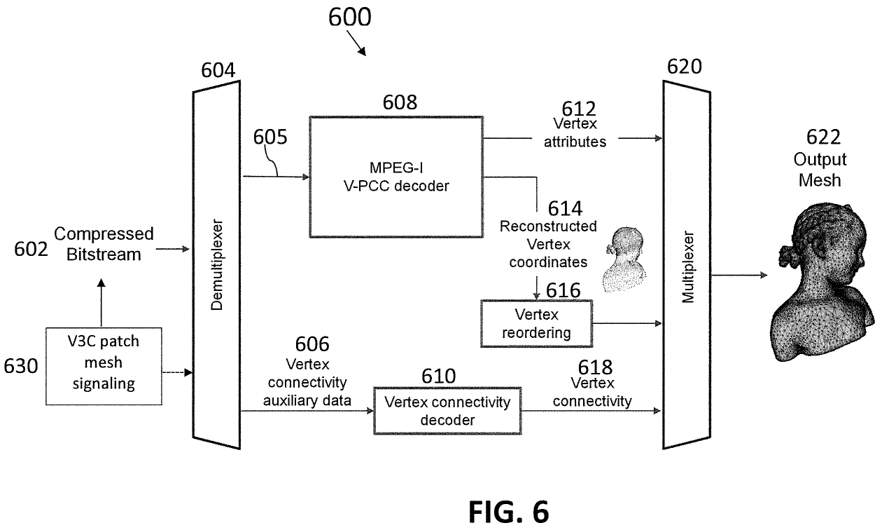

FIG. 5 and FIG. 6 show the extensions to the V-PCC encoder and decoder to support mesh encoding and mesh decoding, respectively, as proposed in MPEG input document

In the encoder extension 500, the input mesh data 502 is demultiplexed with demultiplexer 504 into vertex coordinates+attributes 506 and vertex connectivity 508. The vertex coordinates+attributes data 506 is coded using MPEG-I V-PCC (such as with MPEG-I VPCC encoder 510), whereas the vertex connectivity data 508 is coded (using vertex connectivity encoder 516) as auxiliary data 518. Both of these (encoded vertex coordinates and vertex attributes 517 and auxiliary data 518) are multiplexed using multiplexer 520 to create the final compressed output bitstream 522. Vertex ordering 514 is carried out on the reconstructed vertex coordinates 512 at the output of MPEG-I V-PCC 510 to reorder the vertices for optimal vertex connectivity encoding 516.

Based on the examples described herein, as shown in FIG. 5, the encoding process/apparatus 500 of FIG. 5 may be extended such that the encoding process/apparatus 500 signals V3C patch mesh signaling 530 within the output bitstream 522. Alternatively, V3C patch mesh signaling 530 may be provided and signaled separately from the output bitstream 522.

As shown in FIG. 6, in the decoder 600, the input bitstream 602 is demultiplexed with demultiplexer 604 to generate the compressed bitstreams for vertex coordinates+attributes 605 and vertex connectivity 606. The input/compressed bitstream 602 may comprise or may be the output from the encoder 500, namely the output bitstream 522 of FIG. 5. The vertex coordinates+attributes data 605 is decompressed using MPEG-I V-PCC decoder 608 to generate vertex attributes 612. Vertex ordering 616 is carried out on the reconstructed vertex coordinates 614 at the output of MPEG-I V-PCC decoder 608 to match the vertex order at the encoder 500. The vertex connectivity data 606 is also decompressed using vertex connectivity decoder 610 to generate vertex connectivity information 618, and everything (including vertex attributes 612, the output of vertex reordering 616, and vertex connectivity information 618) is multiplexed with multiplexer 620 to generate the reconstructed mesh 622.

Based on the examples described herein, as shown in FIG. 6, the decoding process/apparatus 600 of FIG. 6 may be extended such that the decoding process/apparatus 600 receives and decodes V3C patch mesh signaling 630, which may be part of the compressed bitstream 602. The V3C patch mesh signaling 630 of FIG. 6 may comprise or correspond to the V3C patch mesh signaling 530 of FIG. 5. Alternatively, V3C patch mesh signaling 630 may be received and signaled separately from the compressed bitstream 602 or output bitstream 522 (e.g. signaled to the demultiplexer 604 separately from the compressed bitstream 602).

Generic Mesh Compression

Mesh data may be compressed directly without projecting it into 2D-planes, like in V-PCC based mesh coding. In fact, the anchor for V-PCC mesh compression call for proposals (CfP) utilizes off-the shelf mesh compression technology, Draco (https://google.github.io/draco/), for compressing mesh data excluding textures. Draco is used to compress vertex positions in 3D, connectivity data (faces) as well as UV coordinates. Additional per-vertex attributes may be also compressed using Draco. The actual UV texture may be compressed using traditional video compression technologies, such as H.265 or H.264.

Draco uses the edgebreaker algorithm at its core to compress 3D mesh information. Draco offers a good balance between simplicity and efficiency, and is part of Khronos endorsed extensions for the glTF specification. The main idea of the algorithm is to traverse mesh triangles in a deterministic way so that each new triangle is encoded next to an already encoded triangle. This enables prediction of vertex specific information from the previously encoded data by simply adding delta to the previous data. Edgebreaker utilizes symbols to signal how each new triangle is connected to the previously encoded part of the mesh. Connecting triangles in such a way results on average in 1 to 2 bits per triangle when combined with existing binary encoding techniques.

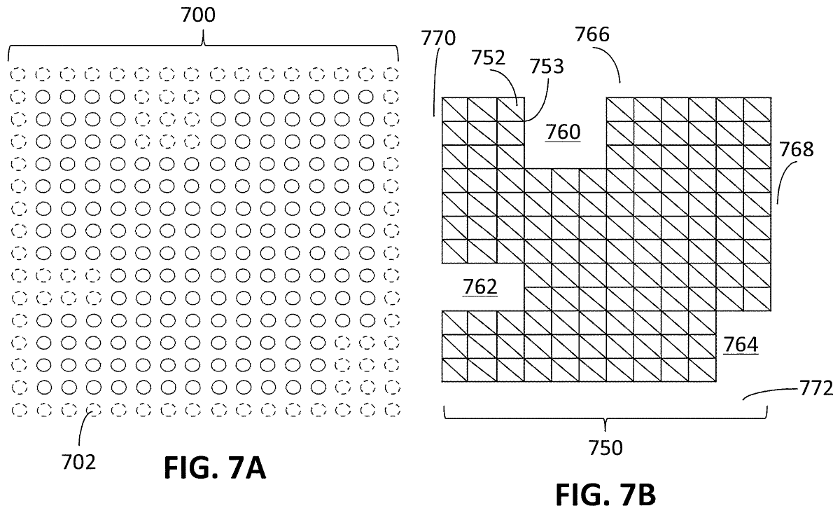

MPEG 3DG (ISO/IEC SC29 WG7) has issued a call for proposal (CfP) on integration of MESH compression into the V3C standard (ISO/IEC 23090-5). During the work on a CfP response owned by the Applicant of the instant disclosure, the Applicant has identified that straightforward regular meshing of V3C patches from depth maps (geometry component) is generating meshes with too many faces 752 and vertices 753 compared to the original encoded mesh, sometimes up to ten times the number of faces 752, an example is shown on FIG. 7B. A high number of faces leads to very slow processing at the decoder and rendering side, and a very large memory footprint that the original mesh would not cause.

Therefore, there is a need for a remeshing approach that keeps the quality of the decoded depth map but outputs a connectivity that is closer to the original mesh, i.e. reduces the number of vertices and faces.

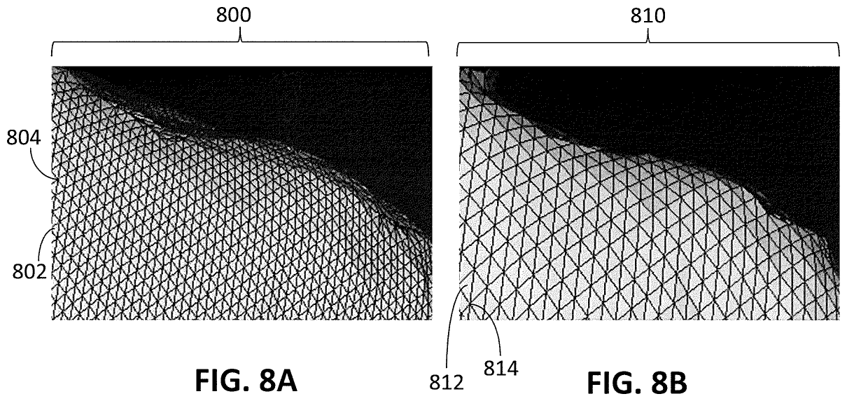

Simple subsampling of the patch depth map (geometry component) may lead to poor geometry quality as represented in FIG. 8B.

The objective is to construct a triangulation of the depth map (geometry component) with i) a minimal number of triangles, ii) triangles with non-degenerate shapes, with a consistently oriented normal, iii) triangles that do not cover unoccupied depth map (geometry component) pixels, iv) vertices that capture well the salient points of the depth map (local maxima and minima), and v) patch borders that are reconstructed with a quality that can be parameterized by the encoder.

Furthermore, the triangulation should support a level-of-detail and/or multi-resolution that is adaptive to the depth map (geometry component), and the triangulation process should be fast and parallelizable.

Accordingly, FIG. 7A shows a patch depth map (geometry component) 700 with unoccupied pixels (e.g. 702) represented as dashed circles. FIG. 7B shows the straightforward regular triangulation 750 of occupied (valid) pixels of the same depth map (geometry component) 700. FIG. 7B shows the regions (760, 762, 764, 766, 768, 770, 772) of the depth map 700 where there are unoccupied pixels 702 within the depth map 700.

FIG. 8A shows a regular meshing 800 of a V3C patch, and FIG. 8B shows simple subsampling 810 of the V3C patch. It can be seen in FIG. 8B that the number of triangles (e.g. number of 812 compared to number of 802) and vertices (number of 814 compared to number of 804) was reduced but with a loss of quality of the geometry; the result 810 shown in FIG. 8B misses some of the shape features and is generally less smooth than the meshing 800 in FIG. 8A and even causes some visible distortions.

Currently signaling related to the preferred triangulation method and related parameters is missing. Thus, signaling related to the preferred triangulation method and related parameters are described herein. The methods described herein describe a re-meshing algorithm, as well as leveraging a layered scalability approach for the re-meshing algorithm.

A lot of research has been done by the computer graphics community on the area of remeshing. For example mesh simplification (also known as decimation) such as mesh simplification based on Quadric Error Metrics (QEMs) to e.g. simplify surfaces with color and texture, or progressive meshes has been introduced. These approaches and most of those based on them rely on a priority queue of edges to be collapsed (or vertices) with costs that depend on some metric computed based on the edge or vertex neighborhood. The process is iterative and costs need to be updated for all edges/vertices for which a neighboring edge or vertex has been collapsed or decimated.

Furthermore, despite the fact some of these approaches, such as those based on QEMs, consider the attributes and not only geometry for the cost estimations, the computational cost increases for limited enhanced quality, for example when using a quadric metric for simplifying meshes with appearance attributes.

Wavelet decompositions is another approach to remesh meshes in a hierarchical representation including filters, such as normal meshes, but the complexity of the approach and the limited compression gains have not enabled these approaches to be used in recent compression frameworks such as the current de facto state-of-the art Draco, that is based on an edgebreaker algorithm (e.g. for connectivity compression for triangle meshes), without any hierarchical or simplification tool. There were also no extensions of the wavelet frameworks to dynamic meshes, but rather a focus on static meshes.

These approaches also do not take into account the nature of V3C patches, that have a depth map (geometry component) with possibly unoccupied pixels and that represent a projection and rasterization of a 3D mesh patch.

Disclosed herein is a method to remesh V3C patches in a way that can be parameterized by the encoder and provided to a decoder in or along V3C bitstream as spatial scalability levels or other types of signaling that are explicitly described hereafter.

Notably the examples described herein allow a mesh to be reconstructed with several resolutions, in the spirit of spatial resolution mesh scalability, so that the decoder can process the decoded V3C patches at different operating points: ranging from coarse meshes at high speed and low memory usage to full resolution meshes at highest quality but with longer execution times and a higher memory footprint. This scalability and flexibility in operating points is desirable for applications where speed and memory consumption are challenging (e.g. XR applications on mobile phones) or where a greener lower power consumption mode is required, or when several meshes need to be decoded and rendered in real-time on the same device. The scalability is also exceptionally useful for enabling lod-based rendering of meshes at different distances from the viewer, where a higher quality is used for objects closer to the viewer and further away objects are rendered with fewer triangles.

The remeshing algorithm is performed in several hierarchical steps that can all be processed in parallel at a depth map (geometry component) block of pixels or pixel level. The algorithm is designed to preserve the geometry characteristics by sampling salient points, and to guarantee that non-degenerate triangles can be regenerated from the encoded patches.

Furthermore, the algorithm produces regions with coarser sampling when the geometry does not present salient features (planar region or smooth curvature region) and regions with finer sampling close to patch borders and on regions where curvature presents several salient points (e.g. topological salient pixels of the curvature field of the shape such as umbilical points).

The approach is numerically efficient as each step exhibits a high level of data processing parallelism and such that the approach processes data from coarse to fine granularity at the boarders of the patches. When high resolution patches need to be remeshed, the remeshing process at each step accesses a subset of pixels of the depth map (geometry component) by resampling or defining small local regions (working groups) for processing; no processing is applied in the full resolution depth map as a whole at any moment.

The herein described approach can lead to decreased quality compared to fine-to-coarse approaches, such as mesh simplification, however, the computational complexity is much lower with higher data parallelism, and well-shaped triangles are guaranteed by construction, which makes the herein described method a good alternative for devices with limited computational capability.

Accordingly, disclosed herein is a method for performing optimization of the remeshing procedure at the encoder side, deriving values for optimized remeshing parameters at different operating points, providing the encoded mesh as a bitstream along with the optimized parameters and scalability information to a decoder, and reconstructing the mesh from the provided bitstream utilizing the optimized parameters at different operating points.

In the herein described method an encoder calculates a set of subsampling factors and provides them to the decoder as spatial scalability layer information. The spatial scalability layer information is firstly provided at the sequence level, e.g. through an extension of ASPS. Each V3C patch can be further amended through V3C patch data unit syntax structure information, when necessary. For example, a V3C patch data syntax structure may provide information to a decoder to be subsampled at a more optimal subsampling factor that may be different along the patch X, Y axis due to the shape of the patch in 2D and in 3D.

The remeshing process used in the herein described method consists of the following items (1-5 immediately following). The syntax elements used in the description of the remeshing process illustrate only one possible implementation of signaling.

1. Initialization

The decoder initializes the layering at the sequence level, e.g. through ASPS information, with: the number of layers, e.g. through asps_num_scalable_layers_minus1, and its sampling rates, e.g. through asps_scalable_layer_sampling_rate[i] for all i from 0 to mri_num_scalable_layers_minus1. This sampling rate indicates that the decoder should sample one geometry component sample every asps_scalable_layer_sampling_rate[i] samples in X and in Y coordinates. This sampling rate can optionally be adapted at the V3C patch level as signaled by the encoder in the V3C bitstream. The sampling rates in X and Y can be specified as different values at the patch level, for example in case of elongated patches.

2. Subsampling

The decoder then produces a coarse mesh corresponding to the lowest scalable layer.

The depth map is subsampled at occupied positions according to the maximum level of subsampling asps_scalable_layer_sampling_rate[0]. This generates the coarsest sampling of the patch geometry component.

Optionally the decoder may sample a patch with a sampling rate that is different from asps_scalable_layer_sampling_rate[0] if the flag pdu_mri_adaptive_sampling_factors_enable_flag is true, and use pdu_mri_adaptive_sampling_factor_delta_X and pdu_mri_adaptive_sampling_factor_delta_Y in X and Y dimensions respectively as a value to be added to the mri_scalable_layer_sampling_rate. Such sampling rate deltas can be optionally specified for each layer pdu_mri_adaptive_sampling_factor_delta_X[i] and pdu_mri_adaptive_sampling_factor_delta_Y[i].

Optionally the patch data unit information can specify that the patch should be discarded at a scalable layer through pdu_mri_skip_patch_at_layer_op[i].

The subsampling may also optionally include filtering. Filtering can include Laplacian or Gaussian pyramids, DWT, low-pass filters etc. that can avoid aliasing issues in this coarse resampling. Such filters should ideally be occupancy-aware; in other words, the filters are able to discard depth (geometry) values that are not valid.

The subsampling may also optionally select one of the nearest occupied pixels (this increases the computational cost).

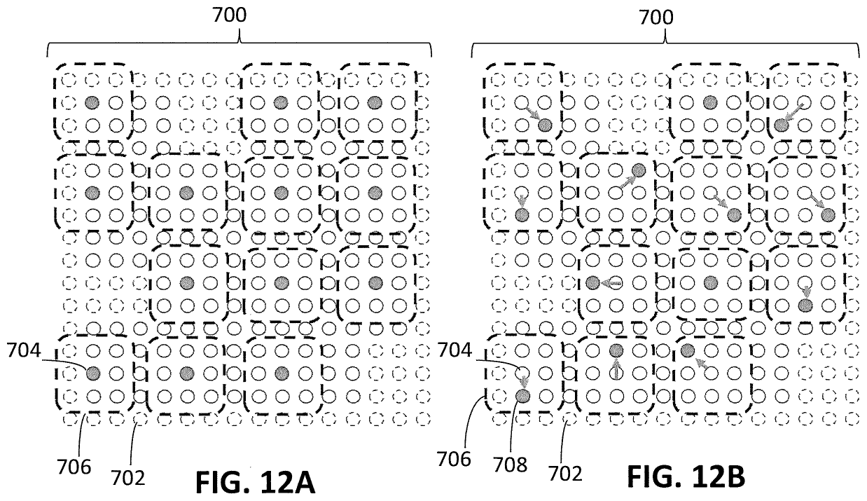

3. Local Optimization: (See FIG. 12A and FIG. 12B)

3.1 The decoder detects salient points in a local window and uses them rather than the first regular subsampled pixel positions. Such salient points can be defined in increasing order of computational complexity as local extrema, singularities of the curvature flow, and points on seams of the texture coordinates or edges of the texture pixels.

Local extrema are the local minimum or maximum of the valid depth (geometry) pixels; detecting such pixels is computationally efficient and they enable the method to better capture the range of the depth (geometry) signal.

Singularities of the curvature flow such as umbilical points are defined such that principal curvatures are equal at these points. While they are not discriminative for planes or smooth simple surfaces such as quadrics, umbilical points of shapes that exhibit more variety in curvature are located at the intersection of the shape curvature principal directions vector field separatrices (lines that separate portions of the shape that have homogeneous curvature flow), which are good candidates for adding vertices in a remeshing process.

Adding points on seams of the texture coordinates or edges of the texture pixels; adding such points ensure a higher quality interpolation of the texture signal once the geometry is remeshed. Such detection may not be complex but the texture component resolution may be higher than the one of the geometry components.

Any combination of the aforementioned points may be the salient points.

3.2 The local window is centered on the subsampled pixel and its size depends on the subsampling factor such that local windows do not overlap and ideally, that a pixel column or row separates them. This ensures well shaped triangles, i.e. a Poisson disk around vertices by construction.

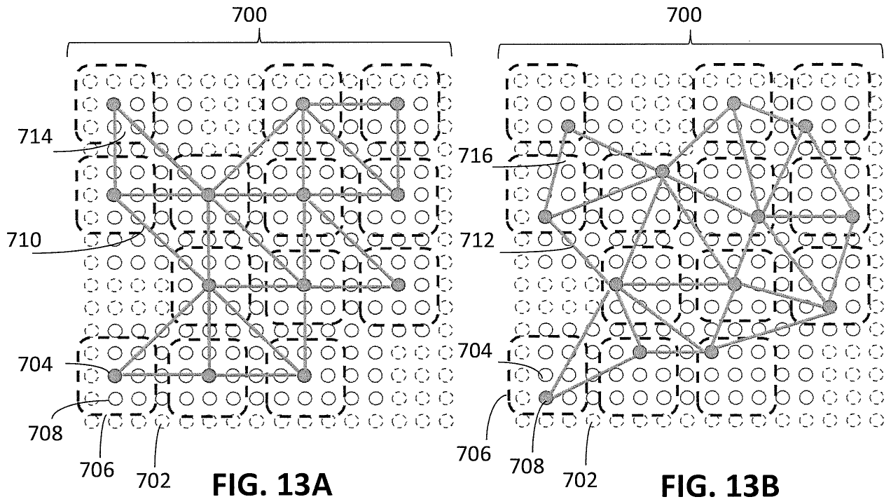

3.3 Triangulate salient points (see FIG. 13A and FIG. 13B). If no salient points are detected, the center of the region is kept instead.

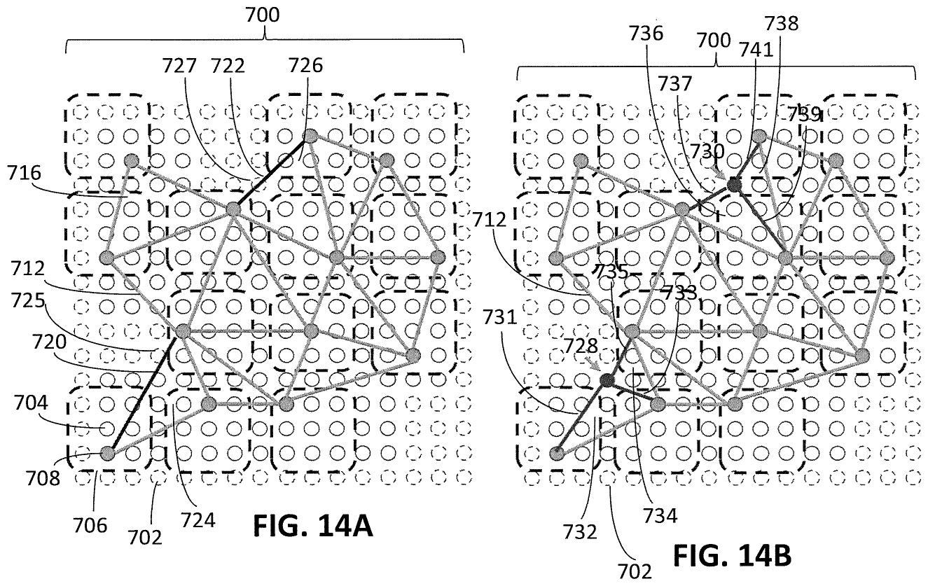

3.4. Occupancy-based correction: (see FIG. 14A and FIG. 14B). The decoder detects triangles that are overlapping unoccupied pixels and splits them until no unoccupied pixel is covered. This process is iterative and a tradeoff can be set by the encoder between quality and number of iterations performed to ensure no coverage of invalid pixels.

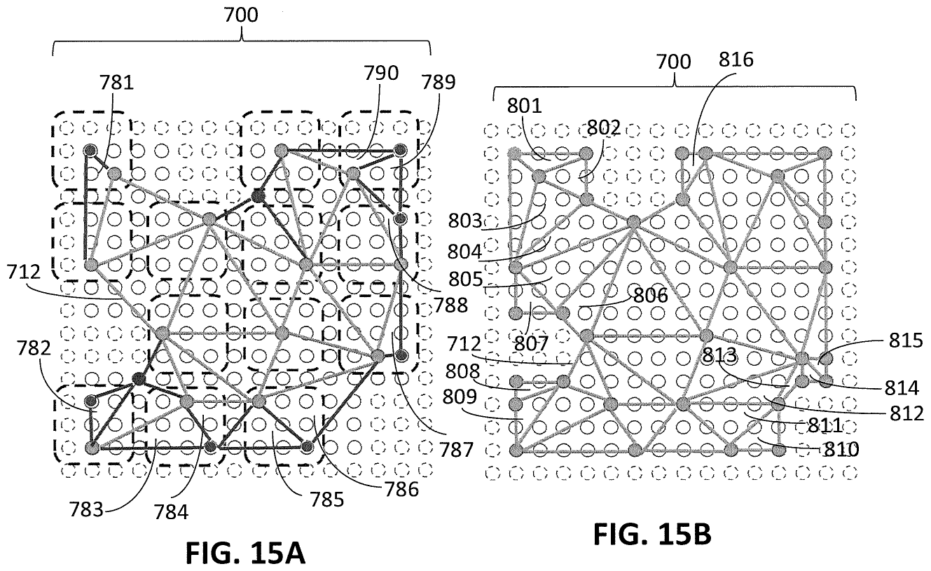

3.5. Refine contours (see FIG. 15A and FIG. 15B). The decoder performs iterative triangle refinement by adding pixel samples to cover N percent of contour pixels. This iterative process can as well be parameterized by the encoder to reach a desired tradeoff between processing speed and final remeshing quality.

3.6. Mesh optimization. The decoder optionally flips edges to maximize geometry smoothness, and/or optionally smooths the resulting mesh.

4. Extracting other layers

The decoding of other layers involves the same sub-items as the initialization and may operate in two ways: 1) layer per layer from the base layer to the next layer until the target layer is reached; the goal is to output as many meshes as there are layers specified by mri_num_scalable_layers_minus1, or 2) directly from the base layer to the target layer, where only the base mesh and the target layer mesh are reconstructed.

When extracting the next layers the subsampling (2), the local optimization (3), especially the refine contours (3.5) and mesh optimization (3.6) are updated as follows (i-iv immediately below).

i) The subsampling operates at the current layer sampling rate on the geometry component, optionally with patch data unit information that signal a delta in the X and/or Y direction. If a geometry component sample is located at the same position, or optionally at a neighboring position, that is already occupied by the sample from the previous layer, then the sample position of the previous layer is kept, otherwise a new sample is added for the current layer. The position of a sample from a previous layer may have been determined through local optimization or occupancy-based correction (steps 3.1, 3.4 of the previous layer) etc., it is not only based on subsampling (step 2) of the previous layer.

ii) The local optimization centers a window on the samples obtained in the previous step, i.e. for a lower layer. If a sample from a previous layer is located in the window, then optionally, this sample is retained, otherwise a new point is selected based on salient point detection.

The following are examples based on the numbering herein:

Mesh with layers 0 and 1
1. Initialization
2. Subsampling of layer 0
3. Local optimization on layer 0
   3.1 to 3.6 are applied
4. Extraction of layer 1
2. Subsampling of layer 1 knowing layer 0
3. Local optimization of layer 1 knowing layer 0
   3.1 to 3.6 are applied

Mesh with 3 layers 0, 1 and 2
Direct mode: target layer is layer 2
1. Initialization
2. Subsampling of layer 0
3. Local optimization on layer 0
   3.1 to 3.6 are applied
4. Extraction of layer 1
2. Subsampling of layer 1 knowing layer 0
3. Local optimization of layer 1 knowing layer 0
   3.1 to 3.4 are applied
4. Extraction of layer 2
2. Subsampling of layer 1 knowing layer 1
3. Local optimization of layer 1 knowing layer 1
   3.1 to 3.6 are applied

Mesh with 3 layers 0, 1 and 2

Direct mode: target layer is layer 2
1. Initialization
2. Subsampling of layer 0
3. Local optimization on layer 0
   3.1 to 3.6 are applied
4. Extraction of layer 1
2. Subsampling of layer 1 knowing layer 0
3. Local optimization of layer 1 knowing layer 0
   3.1 to 3.4 are applied
4. Extraction of layer 2
2. Subsampling of layer 1 knowing layer 1
3. Local optimization of layer 1 knowing layer 1
   3.1 to 3.6 are applied

Mesh with 3 layers 0, 1 and 2

Layer-per-layer mode: target layer is layer 2
1. Initialization
2. Subsampling of layer 0
3. Local optimization on layer 0
   3.1 to 3.6 are applied
4. Extraction of layer 1
2. Subsampling of layer 1 knowing layer 0
3. Local optimization of layer 1 knowing layer 0
   3.1 to 3.6 are applied
4. Extraction of layer 2
2. Subsampling of layer 1 knowing layer 1
3. Local optimization of layer 1 knowing layer 1
   3.1 to 3.6 are applied

iii) In the layer-per-layer mode, the amount of local optimization is reduced due to the presence of samples in the local search windows, while in the direct mode, the local optimization is executed more often especially if the distance between layers in the hierarchy is large.

iv) In case the layer-per-layer mode is selected, 3.5 Refine contours and 3.6 Mesh optimization are applied layer per layer, otherwise in the direct mode, 3.5 Refine contours and 3.6 Mesh optimization are only applied for the target layer.

5. Finalization. For each decoded layer, the texture component is mapped based on the decoded vertices' texture coordinates. The texture component is also down sampled based on the asps_scalable_layer_sampling_rate[i] information, optionally refined at the patch level.

In one embodiment the signaling information related to the method is provided as extensions to atlas_sequence_parameter_set_rbsp( ) and the patch_data_unit( ) syntax elements defined in ISO/IEC 23090-5.

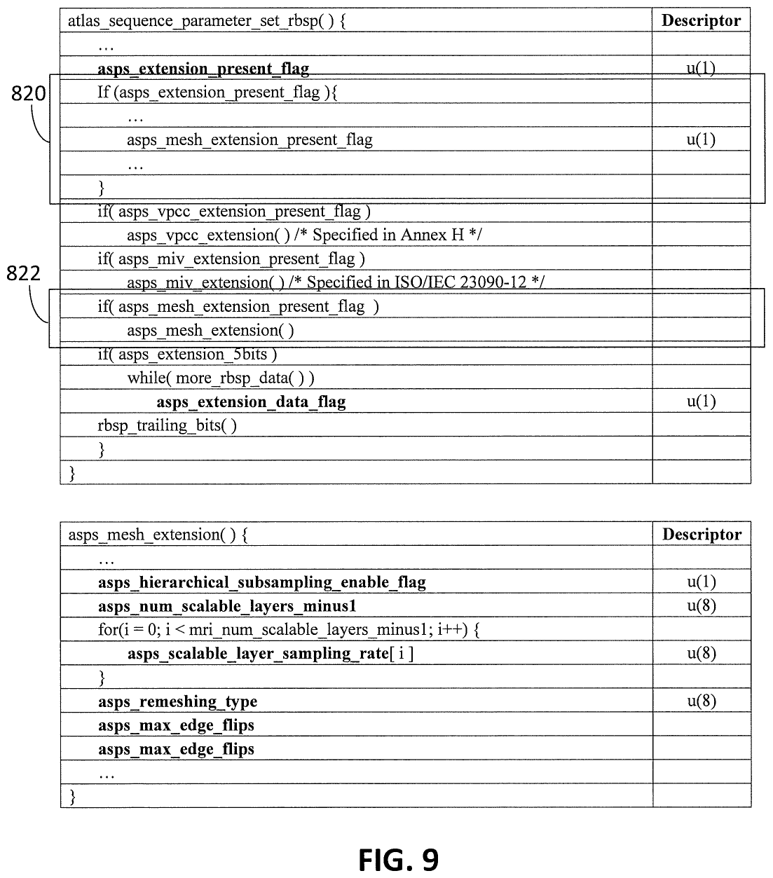

FIG. 9 and below illustrates example signaling of the method described herein as an extension to an atlas sequence parameter set syntax element. Refer to items 820 and 822.

| atlas_sequence_parameter_set_rbsp( ) { | Descriptor |
|---|---|
| ... | |
| asps_extension_present_flag | u(1) |
| If (asps_extension_present_flag ){ | |
| ... | |
| asps_mesh_extension_present_flag | u(1) |
| ... | |
| } | |
| if( asps_vpcc_extension_present_flag ) | |
| asps_vpcc_extension( ) /* Specified in Annex H */ | |
| if( asps_miv_extension_present_flag ) | |
| asps_miv_extension( ) /* Specified in ISO/IEC | |
| 23090-12 */ | |
| if( asps_mesh_extension_present_flag ) | |
| asps_mesh_extension( ) | |
| if( asps_extension_5bits ) | |
| while( more_rbsp_data( ) ) | |
| asps_extension_data_flag | u(1) |
| rbsp_trailing_bits( ) | |
| } | |
| } | |

| asps_mesh_extension( ) { | Descriptor |
|---|---|
| ... | |
| asps_hierarchical_subsampling_enable_flag | u(1) |
| If(asps_hierarchical_subsampling_enable_flag == 1) { | |
| asps_num_scalable_layers_minus1 | u(8) |
| for(i = 0; i < mri_num_scalable_layers_minus1; i++) { | |
| asps_scalable_layer_sampling_rate[ i ] | u(8) |
| } | |
| asps_remeshing_type | u(8) |
| asps_max_edge_flips | |
| asps_smoothing_iter | |
| ... | |
| } | |
| } | |

asps_lodhierachical_enable_flag equal to 1 indicates that the hierarchical subsampling syntax elements are present.

asps_num_scalable_layers_minus1 indicates the number of scalable_layers that can be extracted according to the algorithm presented herein.

asps_scalable_layer_sampling_rate[i] indicates the sampling rate of the scalable layer with index i. Scalable layer index i shall be strictly between 0 and asps_num_scalable_layers_minus1.

asps_remeshing_type indicates the value of subsampling filtering. asps_remeshing_type equal to 0 signals Gaussian pyramids, equal to 1 signals DWT multiresolution, and equal to 2 FIR filter. Values from 3 . . . 255 can provide other types.

asps_max_edge_flips indicates the maximal number of allowed edge flips.

asps_smoothing_iter indicates Laplacian smoothing iterations.

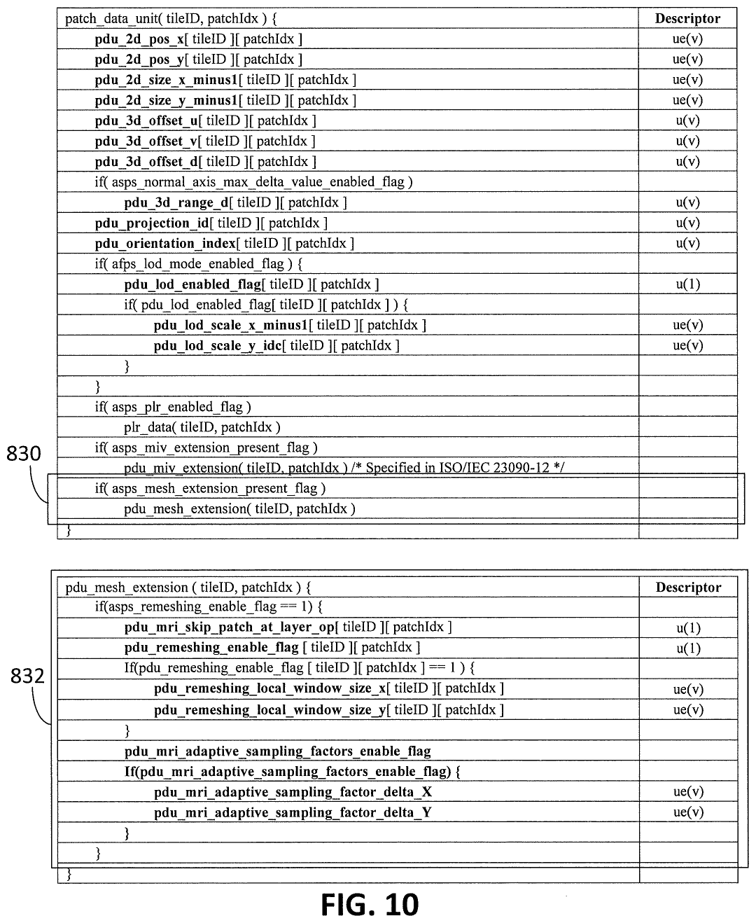

FIG. 10 illustrates example signaling of the method described herein as an extension to a patch data unit syntax element. Refer to items 830 and 832.

| patch_data_unit( tileID, patchIdx ) { | Descriptor |
|---|---|
| pdu_2d_pos_x[ tileID ][ patchIdx ] | ue(v) |
| pdu_2d_pos_y[ tileID ][ patchIdx ] | ue(v) |
| pdu_2d_size_x_minus1[ tileID ][ patchIdx ] | ue(v) |
| pdu_2d_size_y_minus1[ tileID ][ patchIdx ] | ue(v) |
| pdu_3d_offset_u[ tileID ][ patchIdx ] | u(v) |
| pdu_3d_offset_v[ tileID ][ patchIdx ] | u(v) |
| pdu_3d_offset_d[ tileID ][ patchIdx ] | u(v) |
| if( asps_normal_axis_max_delta_value_enabled_flag ) | |
| pdu_3d_range_d[ tileID ][ patchIdx ] | u(v) |
| pdu_projection_id[ tileID ][ patchIdx ] | u(v) |
| pdu_orientation_index[ tileID ][ patchIdx ] | u(v) |
| if( afps_lod_mode_enabled_flag ) { | |
| pdu_lod_enabled_flag[ tileID ][ patchIdx ] | u(1) |
| if( pdu_lod_enabled_flag[ tileID ][ patchIdx] ) { | |
| pdu_lod_scale_x_minus1[ tileID ][ patchIdx ] | ue(v) |
| pdu_lod_scale_y_idc[ tileID ][ patchIdx ] | ue(v) |
| } | |
| } | |
| if( asps_plr_enabled_flag ) | |
| plr_data( tileID, patchIdx ) | |
| if( asps_miv_extension_present_flag ) | |
| pdu_miv_extension( tileID, patchIdx )/* Specified in | |
| ISO/IEC 23090-12 */ | |
| if( asps_mesh_extension_present_flag ) | |
| pdu_mesh_extension( tileID, patchIdx ) | |
| } | |

| pdu_mesh_extension ( tileID, patchIdx ) { | Descriptor |
|---|---|
| if(asps_remeshing_enable_flag == 1) { | |
| pdu_mri_skip_patch_at_layer_op[ tileID ][ patchIdx ] | u(1) |
| pdu_remeshing_enable_flag [ tileID ][ patchIdx ] | u(1) |
| If(pdu_remeshing_enable_flag [tileID ][patchIdx] == 1 ) { | |
| pdu_remeshing_local_window_size_x[ tileID ][ patchIdx ] | ue(v) |
| pdu_remeshing_local_window_size_y[ tileID ][ patchIdx ] | ue(v) |
| } | |
| pdu_mri_adaptive_sampling_factors_enable_flag | |
| If(pdu_mri_adaptive_sampling_factors_enable_flag) { | |
| pdu_mri_adaptive_sampling_factor_delta_X | ue(v) |
| pdu_mri_adaptive_sampling_factor_delta_Y | ue(v) |
| } | |
| } | |
| } | |

pdu_mri_skippatch_at_layer_op[tileID][patchIdx] indicates the operating point from which the patch is used for reconstruction. The operating point is the scalability layer index.

In one embodiment the patches belonging to the same operating point may be grouped in one tile to expose the information on in sequence or frame parameter sets for easy bitstream pruning.

pdu_remeshing_local_window_size_x [tileID][p] indicates the local optimization window size in the x-direction centered at a point in a patch with index p of the current atlas tile, with tile ID equal to tileID, prior to its addition to the patch coordinate TilePatch3dOffsetV[tileID][p].

pdu_remeshing_local_window_size_y [tileID][p] indicates the local optimization window size in the y-direction centered at a point in a patch with index p of the current atlas tile, with tile ID equal to tileID, prior to its addition to the patch coordinate TilePatch3dOffsetV[tileID][p].

pdu_mri_adaptive_sampling_factors_enable_flag [tileID][p] equal to 1 for tile tileID and patch index p indicates that pdu_mri_adaptive_sampling_factor_delta_X and pdu_mri_adaptive_sampling_factor_delta_Y should be interpreted according to the algorithm presented herein.

pdu_mri_adaptive_sampling_factor_delta_X [tileID][p] for tile tileID and patch index p, indicates the delta to be applied to the operating sampling rate asps_scalable_layer_sampling_rate[i] at layer i for the geometry component X dimension. The resulting sampling factor is obtained as pdu_mri_adaptive_sampling_factor_delta_X [tileID][p]+asps_scalable_layer_sampling_rate[i]

pdu_mri_adaptive_sampling_factor_delta_Y [tileID][p] for tile tileID and patch index p, indicates the delta to be applied to the operating sampling rate asps_scalable_layer_sampling_rate[i] at layer i for the geometry component Y dimension. The resulting sampling factor is obtained as pdu_mri_adaptive_sampling_factor_delta_Y [tileID][p]+asps_scalable_layer_sampling_rate[i]

In one embodiment the signaling information related to the method is provided through two SEI messages, one corresponding to sequence level information containing the same information as the asps_mesh_extension( )syntax structure, and one corresponding to patch level information containing the same information as the pdu_mesh_extension (tileID, patchIdx) syntax structure for each tile and patch for which this SEI applies.

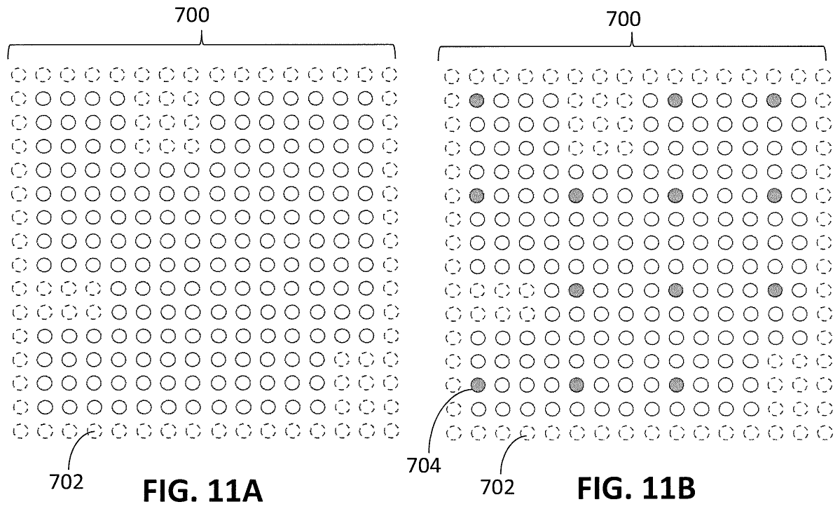

FIG. 11A shows the V3C patch depth map (geometry component) 700 represented with dotted circles (e.g. 702) on invalid/unoccupied pixels. FIG. 11B shows a subsampling (refer to item 704 and other shaded pixels) of the depth map (geometry component) 700 that is signaled in the V3C bitstream for example by pdu_lod_scale_x_minus1 and pdu_lod_scale_y_idc for the x and y axis sampling rate, respectively.

FIG. 12A and FIG. 12B show local optimization. In FIG. 12A, around each subsampled position, a search window (e.g. 706) is defined based on the sampling factor chosen. In FIG. 12B, a salient point (e.g. 708) is selected in the search window 706. This salient point can be an extrema of depth values or any singular point of the curvature such as umbilical points. The size of the search windows is important as the search windows should not overlap and preferably have one raw or column of pixels in between them. This way, the selected pixels can form a well-shaped triangulation as by construction a Poisson disk surrounds each chosen pixel without including any other chosen pixel.

FIG. 13A shows the resulting mesh 710 when no local optimization is performed. FIG. 13B shows the resulting triangulation 712 after local optimization. Despite that the mesh 712 in FIG. 13B may look less regular in 2D then the triangulation 710 shown in FIG. 13A, the mesh 712 in FIG. 13B actually better approximates the 3D shape than the regular triangulation 710 in FIG. 13A. Triangle shapes (714, 716) are non-degenerated in both cases thanks to the sampling rate and local search window size.

FIG. 14A and FIG. 14B show non-coverage of unoccupied pixels (e.g. 702). In FIG. 14A, edges (720, 722) are represented for two triangles (724, 726) that overlap unoccupied pixels (725, 727) in their vicinity. Such triangles (724, 726) would create very visible artifacts. In FIG. 14B, the process of triangle correction based on occupancy shows that a new pixel (728, 730) is sampled close to the triangle edge such that it can create two new triangles (732, 734, 736, 738) that do not overlap non-occupied pixels but still generate a valid triangulation (including with edges 731, 733, 735, 737, 739, 741).

FIG. 15A and FIG. 15B show the refinement step. In FIG. 15A, additional samples and triangles (refer to newly added triangles 781, 782, 783, 784, 785, 786, 787, 788, 789, 790) are added close to the borders. The number of these additional triangles is based on attempting to better capture the border with higher accuracy. FIG. 15B shows the resulting mesh 712 with larger triangles (803, 804, 805, 806) in the core of the patch and finer triangles (801, 802, 807, 808, 809, 810, 811, 812, 813, 814, 815, 816) close to the boundaries. In another embodiment of the method, finer triangles can also be created in the core of the patch, based on the local shape saliency (large triangles for smooth or planar regions and finer triangles for varying curvature areas that require a higher sampling rate). Reference number 712 is maintained through the figures as the mesh changes from the initially generated triangulation 712 after local optimization as in FIG. 13B to the final resulting mesh 712 shown in FIG. 15B.

Ideas herein are to be contributed to standardization in ISO/IEC SC 29 WG7 as part of response to CfP on mesh coding.

Structures and concepts described herein may be included as normative text in a standard.

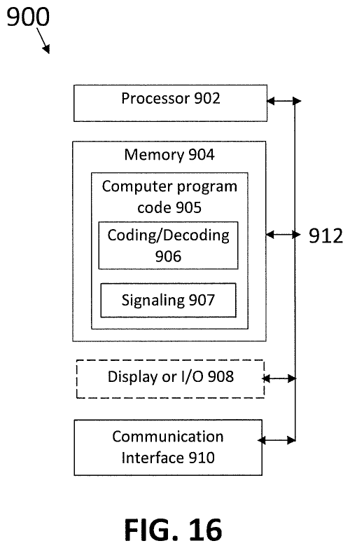

FIG. 16 is an apparatus 900 which may be implemented in hardware, configured to implement V3C patch remeshing for dynamic mesh coding, including hierarchical V3C patch remeshing for dynamic mesh coding, based on any of the examples described herein. The apparatus comprises a processor 902, at least one memory 904 (memory 904 may be transitory or non-transitory) including computer program code 905, wherein the at least one memory 904 and the computer program code 905 are configured to, with the at least one processor 902, cause the apparatus to implement circuitry, a process, component, module, function, coding, and/or decoding (collectively 906) to implement V3C patch remeshing for dynamic mesh coding, including hierarchical V3C patch remeshing for dynamic mesh coding, based on the examples described herein. The apparatus 900 is further configured to provide or receive signaling 907, based on the signaling embodiments described herein. The apparatus 900 optionally includes a display and/or I/O interface 908 that may be used to display an output (e.g., an image or volumetric video) of a result of coding/decoding 906. The display and/or I/O interface 908 may also be configured to receive input such as user input (e.g. with a keypad, touchscreen, touch area, microphone, biometric recognition etc.). The apparatus 900 also includes one or more communication interfaces (I/F(s)) 910, such as a network (NW) interface. The communication I/F(s) 910 may be wired and/or wireless and communicate over a channel or the Internet/other network(s) via any communication technique. The communication I/F(s) 910 may comprise one or more transmitters and one or more receivers. The communication I/F(s) 910 may comprise standard well-known components such as an amplifier, filter, frequency-converter, (de)modulator, and encoder/decoder circuitry(ies) and one or more antennas. In some examples, the processor 902 is configured to implement item 906 and/or item 907 without use of memory 904.

The apparatus 900 may be a remote, virtual or cloud apparatus. The apparatus 900 may be either a writer or a reader (e.g. parser), or both a writer and a reader (e.g. parser). The apparatus 900 may be either a coder or a decoder, or both a coder and a decoder (codec). The apparatus 900 may be a user equipment (UE), a head mounted display (HMD), or any other fixed or mobile device.

The memory 904 may be implemented using any suitable data storage technology, such as semiconductor based memory devices, flash memory, magnetic memory devices and systems, optical memory devices and systems, fixed memory and removable memory. The memory 904 may comprise a database for storing data. Interface 912 enables data communication between the various items of apparatus 900, as shown in FIG. 16. Interface 912 may be one or more buses, or interface 912 may be one or more software interfaces configured to pass data within computer program code 905. For example, the interface 912 may be one or more buses such as address, data, or control buses, and may include any interconnection mechanism, such as a series of lines on a motherboard or integrated circuit, fiber optics or other optical communication equipment, and the like. In another example, interface 912 is an object-oriented software interface. The apparatus 900 need not comprise each of the features mentioned, or may comprise other features as well. The apparatus 900 may be an embodiment of and have the features of any of the apparatuses shown in FIG. 1A, FIG. 1B, FIG. 5, and/or FIG. 6.

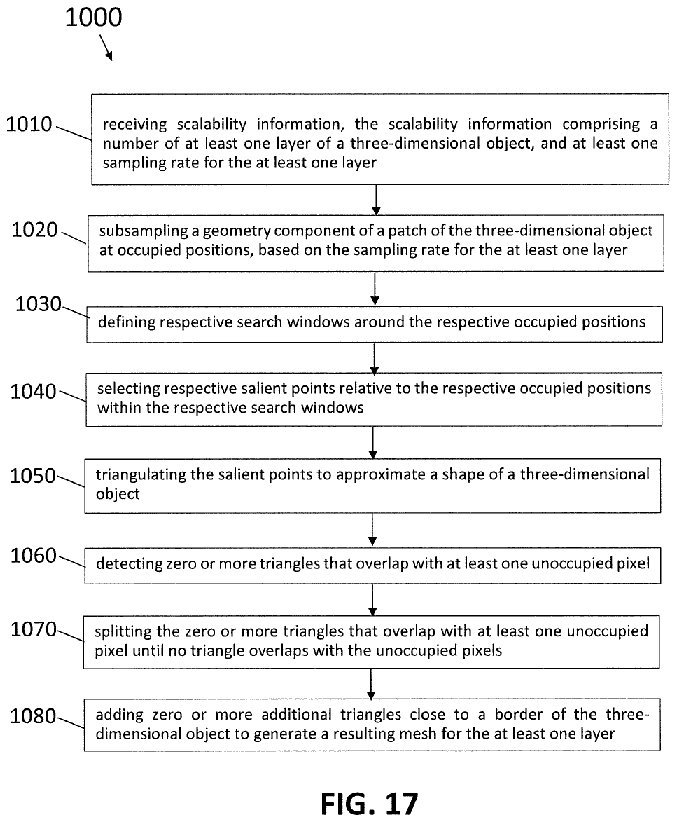

FIG. 17 is a method 1000 to implement hierarchical V3C patch remeshing for dynamic mesh coding, based on the examples described herein. At 1010, the method includes receiving scalability information, the scalability information comprising a number of at least one layer of a three-dimensional object, and at least one sampling rate for the at least one layer. At 1020, the method includes subsampling a geometry component of a patch of the three-dimensional object at occupied positions, based on the sampling rate for the at least one layer. At 1030, the method includes defining respective search windows around the respective occupied positions. At 1040, the method includes selecting respective salient points relative to the respective occupied positions within the respective search windows. At 1050, the method includes triangulating the salient points to approximate a shape of a three-dimensional object. At 1060, the method includes detecting zero or more triangles that overlap with at least one unoccupied pixel. At 1070, the method includes splitting the zero or more triangles that overlap with at least one unoccupied pixel until no triangle overlaps with the unoccupied pixels. At 1080, the method includes adding zero or more additional triangles close to a border of the three-dimensional object to generate a resulting mesh for the at least one layer. Method 1000 may be performed with apparatus 500, apparatus 600, apparatus 900, an encoding apparatus, or a decoding apparatus.

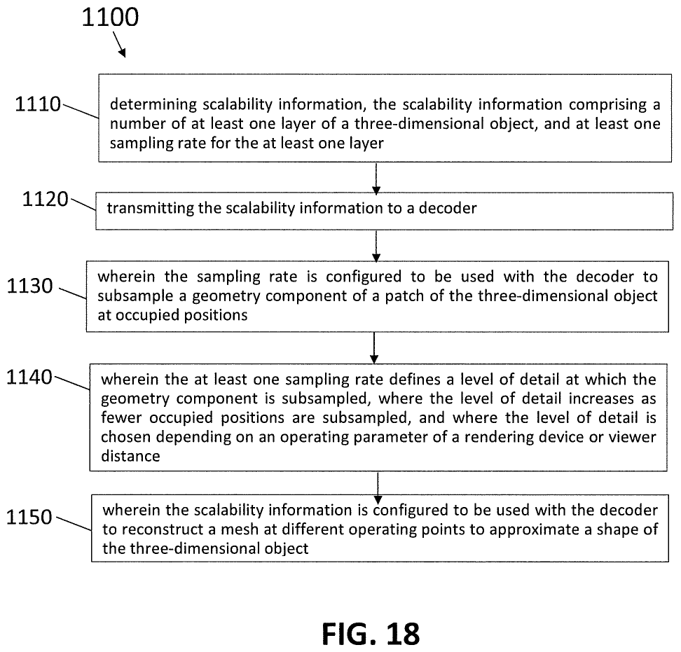

FIG. 18 is a method 1100 to implement hierarchical V3C patch remeshing for dynamic mesh coding, based on the examples described herein. At 1110, the method includes determining scalability information, the scalability information comprising a number of at least one layer of a three-dimensional object, and at least one sampling rate for the at least one layer. At 1120, the method includes transmitting the scalability information to a decoder. At 1130, the method includes wherein the sampling rate is configured to be used with the decoder to subsample a geometry component of a patch of the three-dimensional object at occupied positions. At 1140, the method includes wherein the at least one sampling rate defines a level of detail at which the geometry component is subsampled, where the level of detail increases as fewer occupied positions are subsampled, and where the level of detail is chosen depending on an operating parameter of a rendering device or viewer distance. At 1150, the method includes wherein the scalability information is configured to be used with the decoder to reconstruct a mesh at different operating points to approximate a shape of the three-dimensional object. Method 1100 may be performed with the apparatus 500, apparatus 900, or an encoding apparatus.

As used herein, a level of detail may refer to a level of coarseness.

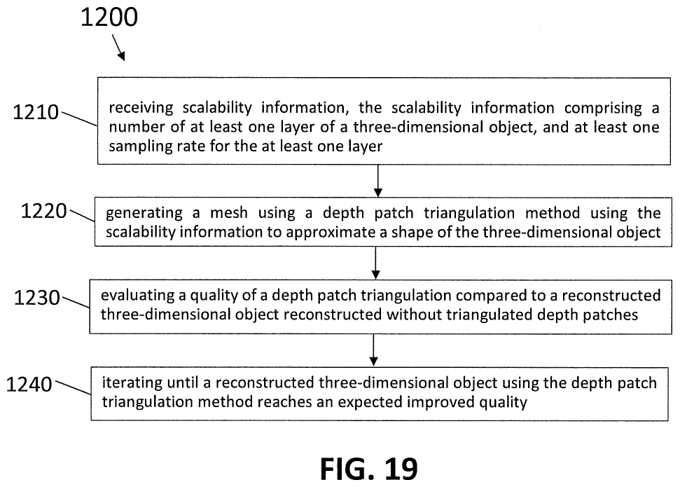

FIG. 19 is a method 1200 to implement hierarchical V3C patch remeshing for dynamic mesh coding, based on the examples described herein. At 1210, the method includes receiving scalability information, the scalability information comprising a number of at least one layer of a three-dimensional object, and at least one sampling rate for the at least one layer. At 1220, the method includes generating a mesh using a depth patch triangulation method using the scalability information to approximate a shape of the three-dimensional object. At 1230, the method includes evaluating a quality of a depth patch triangulation compared to a reconstructed three-dimensional object reconstructed without triangulated depth patches. At 1240, the method includes iterating until a reconstructed three-dimensional object using the depth patch triangulation method reaches an expected improved quality. Method 1200 may be performed with the apparatus 600, apparatus 900, or a decoding apparatus.

The following examples 1-29 are described herein.

Example 1: An apparatus includes at least one processor; and at least one memory including computer program code; wherein the at least one memory and the computer program code are configured to, with the at least one processor, cause the apparatus at least to: receive scalability information, the scalability information comprising a number of at least one layer of a three-dimensional object, and at least one sampling rate for the at least one layer; subsample a geometry component of a patch of the three-dimensional object at occupied positions, based on the sampling rate for the at least one layer; define respective search windows around the respective occupied positions; select respective salient points relative to the respective occupied positions within the respective search windows; triangulate the salient points to approximate a shape of a three-dimensional object; detect zero or more triangles that overlap with at least one unoccupied pixel; split the zero or more triangles that overlap with at least one unoccupied pixel until no triangle overlaps with the unoccupied pixels; and add zero or more additional triangles close to a border of the three-dimensional object to generate a resulting mesh for the at least one layer.

Example 2: The apparatus of example 1, wherein the at least one memory and the computer program code are further configured to, with the at least one processor, cause the apparatus at least to: initialize, through atlas sequence parameter set information, the at least one layer and the at least one sampling rate.

Example 3: The apparatus of any of examples 1 to 2, wherein the at least one sampling rate defines a level of detail at which the geometry component is subsampled, where the level of detail increases as fewer occupied positions are subsampled, and where the level of detail is chosen depending on an operating parameter of a rendering device or viewer distance.

Example 4: The apparatus of any of examples 1 to 3, wherein the at least one sampling rate differs for different layers of the at least one layer.

Example 5: The apparatus of any of examples 1 to 4, wherein the at least one memory and the computer program code are further configured to, with the at least one processor, cause the apparatus at least to: receive adaptive sampling signaling comprising a flag indicating whether adaptive sampling is enabled; and add a delta to the at least one sampling rate, in response to the adaptive sampling being enabled.

Example 6: The apparatus of any of examples 1 to 5, wherein the at least one memory and the computer program code are further configured to, with the at least one processor, cause the apparatus at least to: receive signaling indicating that the patch should be discarded at the at least one layer.

Example 7: The apparatus of any of examples 1 to 6, wherein the at least one memory and the computer program code are further configured to, with the at least one processor, cause the apparatus at least to: maintain a first sample position of a previous layer for a current layer, in response to a second sample of the current layer being located at a common or neighboring position of a first sample of the previous layer; and add a second sample position for the current layer, in response to the second sample of the current layer not being located at the common or neighboring position of the first sample of the previous layer.

Example 8: The apparatus of any of examples 1 to 7, wherein the at least one memory and the computer program code are further configured to, with the at least one processor, cause the apparatus at least to: update the subsampling of the geometry component for a current layer; and center a window of the respective search windows around samples generated based on the updated subsampling; retain a first sample from a previous layer, in response to the first sample being located within the centered window; and detect a new salient point, in response to the first sample not being located within the centered window.

Example 9: The apparatus of any of examples 1 to 8, wherein the defining of the respective search windows, and the selecting of the respective salient points are performed more frequently, in response to a distance between layers being greater than a threshold.

Example 10: The apparatus of any of examples 1 to 9, wherein the at least one memory and the computer program code are further configured to, with the at least one processor, cause the apparatus at least to: map a texture component based on respective texture coordinates for a set of respective vertices; and downsample the texture component, based on the at least one layer.

Example 11: The apparatus of any of examples 1 to 10, wherein: the scalability information is received as an extension to an atlas sequence parameter set raw byte sequence payload; or the scalability information is received as an extension to a patch data unit.

Example 12: The apparatus of any of examples 1 to 11, wherein the at least one memory and the computer program code are further configured to, with the at least one processor, cause the apparatus at least to: group patches belonging to a common operating point in a tile; and provide information related to a sequence of at least one frame parameter set for bitstream pruning.

Example 13: An apparatus includes at least one processor; and at least one memory including computer program code; wherein the at least one memory and the computer program code are configured to, with the at least one processor, cause the apparatus at least to: determine scalability information, the scalability information comprising a number of at least one layer of a three-dimensional object, and at least one sampling rate for the at least one layer; and transmit the scalability information to a decoder; wherein the sampling rate is configured to be used with the decoder to subsample a geometry component of a patch of the three-dimensional object at occupied positions; wherein the at least one sampling rate defines a level of detail at which the geometry component is subsampled, where the level of detail increases as fewer occupied positions are subsampled, and where the level of detail is chosen depending on an operating parameter of a rendering device or viewer distance; wherein the scalability information is configured to be used with the decoder to reconstruct a mesh at different operating points to approximate a shape of the three-dimensional object.

Example 14: The apparatus of example 13, wherein the at least one memory and the computer program code are further configured to, with the at least one processor, cause the apparatus at least to: transmit adaptive sampling signaling comprising a flag indicating whether adaptive sampling is enabled; wherein the adaptive sampling signaling is configured to be used with the decoder to add a delta to the at least one sampling rate, in response to the adaptive sampling being enabled.

Example 15: The apparatus of any of examples 13 to 14, wherein the at least one memory and the computer program code are further configured to, with the at least one processor, cause the apparatus at least to: transmit signaling indicating that the patch should be discarded at the at least one layer.

Example 16: The apparatus of any of examples 13 to 15, wherein: the scalability information is transmitted as an extension to an atlas sequence parameter set raw byte sequence payload; or the scalability information is transmitted as an extension to a patch data unit.

Example 17: An apparatus includes at least one processor; and at least one memory including computer program code; wherein the at least one memory and the computer program code are configured to, with the at least one processor, cause the apparatus at least to: receive scalability information, the scalability information comprising a number of at least one layer of a three-dimensional object, and at least one sampling rate for the at least one layer; generate a mesh using a depth patch triangulation method using the scalability information to approximate a shape of the three-dimensional object; evaluate a quality of a depth patch triangulation compared to a reconstructed three-dimensional object reconstructed without triangulated depth patches; and iterate until a reconstructed three-dimensional object using the depth patch triangulation method reaches an expected improved quality.

Example 18: The apparatus of example 17, wherein the at least one sampling rate defines a level of detail at which the geometry component is subsampled, where the level of detail increases as fewer occupied positions are subsampled, and where the level of detail is chosen depending on an operating parameter of a rendering device or viewer distance.

Example 19: The apparatus of any of examples 17 to 18, wherein the at least one memory and the computer program code are further configured to, with the at least one processor, cause the apparatus at least to: receive adaptive sampling signaling comprising a flag indicating whether adaptive sampling is enabled; and add a delta to the at least one sampling rate, in response to the adaptive sampling being enabled.

Example 20: The apparatus of any of examples 17 to 19, wherein: the scalability information is received as an extension to an atlas sequence parameter set raw byte sequence payload; or the scalability information is received as an extension to a patch data unit.

Example 21: A method includes receiving scalability information, the scalability information comprising a number of at least one layer of a three-dimensional object, and at least one sampling rate for the at least one layer; subsampling a geometry component of a patch of the three-dimensional object at occupied positions, based on the sampling rate for the at least one layer; defining respective search windows around the respective occupied positions; selecting respective salient points relative to the respective occupied positions within the respective search windows; triangulating the salient points to approximate a shape of a three-dimensional object; detecting zero or more triangles that overlap with at least one unoccupied pixel; splitting the zero or more triangles that overlap with at least one unoccupied pixel until no triangle overlaps with the unoccupied pixels; and adding zero or more additional triangles close to a border of the three-dimensional object to generate a resulting mesh for the at least one layer.

Example 22: A method includes determining scalability information, the scalability information comprising a number of at least one layer of a three-dimensional object, and at least one sampling rate for the at least one layer; and transmitting the scalability information to a decoder; wherein the sampling rate is configured to be used with the decoder to subsample a geometry component of a patch of the three-dimensional object at occupied positions; wherein the at least one sampling rate defines a level of detail at which the geometry component is subsampled, where the level of detail increases as fewer occupied positions are subsampled, and where the level of detail is chosen depending on an operating parameter of a rendering device or viewer distance; wherein the scalability information is configured to be used with the decoder to reconstruct a mesh at different operating points to approximate a shape of the three-dimensional object.

Example 23: A method includes receiving scalability information, the scalability information comprising a number of at least one layer of a three-dimensional object, and at least one sampling rate for the at least one layer; generating a mesh using a depth patch triangulation method using the scalability information to approximate a shape of the three-dimensional object; evaluating a quality of a depth patch triangulation compared to a reconstructed three-dimensional object reconstructed without triangulated depth patches; and iterating until a reconstructed three-dimensional object using the depth patch triangulation method reaches an expected improved quality.

Example 24: An apparatus includes means for receiving scalability information, the scalability information comprising a number of at least one layer of a three-dimensional object, and at least one sampling rate for the at least one layer; means for subsampling a geometry component of a patch of the three-dimensional object at occupied positions, based on the sampling rate for the at least one layer; means for defining respective search windows around the respective occupied positions; means for selecting respective salient points relative to the respective occupied positions within the respective search windows; means for triangulating the salient points to approximate a shape of a three-dimensional object; means for detecting zero or more triangles that overlap with at least one unoccupied pixel; means for splitting the zero or more triangles that overlap with at least one unoccupied pixel until no triangle overlaps with the unoccupied pixels; and means for adding zero or more additional triangles close to a border of the three-dimensional object to generate a resulting mesh for the at least one layer.

Example 25: An apparatus includes means for determining scalability information, the scalability information comprising a number of at least one layer of a three-dimensional object, and at least one sampling rate for the at least one layer; and means for transmitting the scalability information to a decoder; wherein the sampling rate is configured to be used with the decoder to subsample a geometry component of a patch of the three-dimensional object at occupied positions; wherein the at least one sampling rate defines a level of detail at which the geometry component is subsampled, where the level of detail increases as fewer occupied positions are subsampled, and where the level of detail is chosen depending on an operating parameter of a rendering device or viewer distance; wherein the scalability information is configured to be used with the decoder to reconstruct a mesh at different operating points to approximate a shape of the three-dimensional object.

Example 26: An apparatus includes means for receiving scalability information, the scalability information comprising a number of at least one layer of a three-dimensional object, and at least one sampling rate for the at least one layer; means for generating a mesh using a depth patch triangulation method using the scalability information to approximate a shape of the three-dimensional object; means for evaluating a quality of a depth patch triangulation compared to a reconstructed three-dimensional object reconstructed without triangulated depth patches; and means for iterating until a reconstructed three-dimensional object using the depth patch triangulation method reaches an expected improved quality.

Example 27: A non-transitory program storage device readable by a machine, tangibly embodying a program of instructions executable with the machine for performing operations is described and provided, the operations comprising: receiving scalability information, the scalability information comprising a number of at least one layer of a three-dimensional object, and at least one sampling rate for the at least one layer; subsampling a geometry component of a patch of the three-dimensional object at occupied positions, based on the sampling rate for the at least one layer; defining respective search windows around the respective occupied positions; selecting respective salient points relative to the respective occupied positions within the respective search windows; triangulating the salient points to approximate a shape of a three-dimensional object; detecting zero or more triangles that overlap with at least one unoccupied pixel; splitting the zero or more triangles that overlap with at least one unoccupied pixel until no triangle overlaps with the unoccupied pixels; and adding zero or more additional triangles close to a border of the three-dimensional object to generate a resulting mesh for the at least one layer.

Example 28: A non-transitory program storage device readable by a machine, tangibly embodying a program of instructions executable with the machine for performing operations is described and provided, the operations comprising: determining scalability information, the scalability information comprising a number of at least one layer of a three-dimensional object, and at least one sampling rate for the at least one layer; and transmitting the scalability information to a decoder; wherein the sampling rate is configured to be used with the decoder to subsample a geometry component of a patch of the three-dimensional object at occupied positions; wherein the at least one sampling rate defines a level of detail at which the geometry component is subsampled, where the level of detail increases as fewer occupied positions are subsampled, and where the level of detail is chosen depending on an operating parameter of a rendering device or viewer distance; wherein the scalability information is configured to be used with the decoder to reconstruct a mesh at different operating points to approximate a shape of the three-dimensional object.

Example 29: A non-transitory program storage device readable by a machine, tangibly embodying a program of instructions executable with the machine for performing operations is described and provided, the operations comprising: receiving scalability information, the scalability information comprising a number of at least one layer of a three-dimensional object, and at least one sampling rate for the at least one layer; generating a mesh using a depth patch triangulation method using the scalability information to approximate a shape of the three-dimensional object; evaluating a quality of a depth patch triangulation compared to a reconstructed three-dimensional object reconstructed without triangulated depth patches; and iterating until a reconstructed three-dimensional object using the depth patch triangulation method reaches an expected improved quality.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry may also be used to mean a function or a process, such as one implemented by an encoder or decoder, or a codec.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:
2D or 2d two-dimensional
3D or 3d three-dimensional
3DG 3D graphics coding group
6DOF six degrees of freedom
ACL atlas coding layer
AFPS atlas frame parameter set
AR augmented reality
ASIC application-specific integrated circuit
asps or ASPS atlas sequence parameter set
CD committee draft
CfP call for proposals
CGI computer-generated imagery
DWT discrete wavelet transform
FIR finite impulse response
glTF graphics language transmission format
H.264 advanced video coding video compression standard
H.265 high efficiency video coding video compression standard
HMD head mounted display
id or ID identifier
idc indication
Idx index
IEC International Electrotechnical Commission
I/F interface
I/O input/output
ISO International Organization for Standardization
lod level of detail(s)
miv or MIV MPEG immersive video
MPEG moving picture experts group
MPEG-I MPEG immersive
MR mixed reality
NAL network abstraction layer
NW network
pdu patch data unit
pos position, or files containing text descriptions of a position
QEM quadric error metric
rbsp or RBSP raw byte sequence payload
SC subcommittee
u(n) unsigned integer using n bits, e.g. u(1), u(2)
UE user equipment
ue(v) unsigned integer exponential Golomb coded syntax element with the left bit first
UV coordinate texture, where “U” and “V” are axes of a 2D texture
u(v) unsigned integer, where the number of bits is determined by the value of other syntax elements
V3C visual volumetric video-based coding
VPCC or V-PCC video-based point cloud coding/compression
VPS V3C parameter set
VR virtual reality
WG working group
XR mixed reality

What is claimed is:

1. An apparatus comprising:
at least one processor; and
at least one non-transitory memory storing instructions that, when executed by the at least one processor, cause the apparatus at least to:
receive scalability information, the scalability information comprising a number of at least one layer of a three-dimensional object, and at least one sampling rate for the at least one layer;
subsample a geometry component of a patch of the three-dimensional object at occupied positions, based on the sampling rate for the at least one layer;
define respective search windows around the respective occupied positions;
select respective salient points relative to the respective occupied positions within the respective search windows;
triangulate the salient points to approximate a shape of a three-dimensional object;
detect zero or more triangles that overlap with at least one unoccupied pixel;
split the zero or more triangles that overlap with at least one unoccupied pixel until no triangle overlaps with the unoccupied pixels; and
add zero or more additional triangles close to a border of the three-dimensional object to generate a resulting mesh for the at least one layer.

2. The apparatus of claim 1, wherein the instructions, when executed by the at least one processor, cause the apparatus at least to:
initialize, through atlas sequence parameter set information, the at least one layer and the at least one sampling rate.

3. The apparatus of claim 1, wherein the at least one sampling rate defines a level of detail at which the geometry component is subsampled, where the level of detail increases as fewer occupied positions are subsampled, and where the level of detail is chosen depending on an operating parameter of a rendering device or viewer distance.

4. The apparatus of claim 1, wherein the at least one sampling rate differs for different layers of the at least one layer.

5. The apparatus of claim 1, wherein the instructions, when executed by the at least one processor, cause the apparatus at least to:
receive adaptive sampling signaling comprising a flag indicating whether adaptive sampling is enabled; and
add a delta to the at least one sampling rate, in response to the adaptive sampling being enabled.

6. The apparatus of claim 1, wherein the instructions, when executed by the at least one processor, cause the apparatus at least to:
receive signaling indicating that the patch should be discarded at the at least one layer.

7. The apparatus of claim 1, wherein the instructions, when executed by the at least one processor, cause the apparatus at least to:
maintain a first sample position of a previous layer for a current layer, in response to a second sample of the current layer being located at a common or neighboring position of a first sample of the previous layer; and
add a second sample position for the current layer, in response to the second sample of the current layer not being located at the common or neighboring position of the first sample of the previous layer.

8. The apparatus of claim 1, wherein the instructions, when executed by the at least one processor, cause the apparatus at least to:
update the subsampling of the geometry component for a current layer; and
center a window of the respective search windows around samples generated based on the updated subsampling;
retain a first sample from a previous layer, in response to the first sample being located within the centered window; and
detect a new salient point, in response to the first sample not being located within the centered window.

9. The apparatus of claim 1, wherein the defining of the respective search windows, and the selecting of the respective salient points are performed more frequently, in response to a distance between layers being greater than a threshold.

10. The apparatus of claim 1, wherein the instructions, when executed by the at least one processor, cause the apparatus at least to:
map a texture component based on respective texture coordinates for a set of respective vertices; and
downsample the texture component, based on the at least one layer.

11. The apparatus of claim 1, wherein:
the scalability information is received as an extension to an atlas sequence parameter set raw byte sequence payload; or
the scalability information is received as an extension to a patch data unit.

12. The apparatus of claim 1, wherein the instructions, when executed by the at least one processor, cause the apparatus at least to:
group patches belonging to a common operating point in a tile; and
provide information related to a sequence of at least one frame parameter set for bitstream pruning.

13. An apparatus comprising:
at least one processor; and
at least one non-transitory memory storing instructions that, when executed by the at least one processor, cause the apparatus at least to:
determine scalability information, the scalability information comprising a number of at least one layer of a three-dimensional object, and at least one sampling rate for the at least one layer; and
transmit the scalability information to a decoder;
wherein the sampling rate is configured to be used with the decoder to subsample a geometry component of a patch of the three-dimensional object at occupied positions;
wherein the at least one sampling rate defines a level of detail at which the geometry component is subsampled, where the level of detail increases as fewer occupied positions are subsampled, and where the level of detail is chosen depending on an operating parameter of a rendering device or viewer distance;
wherein the scalability information is configured to be used with the decoder to reconstruct a mesh at different operating points to approximate a shape of the three-dimensional object.

14. The apparatus of claim 13, wherein the instructions, when executed by the at least one processor, cause the apparatus at least to:
transmit adaptive sampling signaling comprising a flag indicating whether adaptive sampling is enabled;
wherein the adaptive sampling signaling is configured to be used with the decoder to add a delta to the at least one sampling rate, in response to the adaptive sampling being enabled.

15. The apparatus of claim 13, wherein the instructions, when executed by the at least one processor, cause the apparatus at least to:
transmit signaling indicating that the patch should be discarded at the at least one layer.

16. The apparatus of claim 13, wherein:
the scalability information is transmitted as an extension to an atlas sequence parameter set raw byte sequence payload; or
the scalability information is transmitted as an extension to a patch data unit.

17. An apparatus comprising:
at least one processor; and
at least one non-transitory memory storing instructions that, when executed by the at least one processor, cause the apparatus at least to:
receive scalability information, the scalability information comprising a number of at least one layer of a three-dimensional object, and at least one sampling rate for the at least one layer;
generate a mesh using a depth patch triangulation method using the scalability information to approximate a shape of the three-dimensional object;
evaluate a quality of a depth patch triangulation compared to a reconstructed three-dimensional object reconstructed without triangulated depth patches; and
iterate until a reconstructed three-dimensional object using the depth patch triangulation method reaches an expected improved quality.

18. The apparatus of claim 17, wherein the at least one sampling rate defines a level of detail at which the geometry component is subsampled, where the level of detail increases as fewer occupied positions are subsampled, and where the level of detail is chosen depending on an operating parameter of a rendering device or viewer distance.

19. The apparatus of claim 17, wherein the instructions, when executed by the at least one processor, cause the apparatus at least to:
receive adaptive sampling signaling comprising a flag indicating whether adaptive sampling is enabled; and
add a delta to the at least one sampling rate, in response to the adaptive sampling being enabled.

20. The apparatus of claim 17, wherein:
the scalability information is received as an extension to an atlas sequence parameter set raw byte sequence payload; or
the scalability information is received as an extension to a patch data unit.
